(19) United States
(12) Patent Application Publication
(10) Pub. No.: US 2020/0240888 A1
(43) Pub. Date: Jul. 30, 2020

(54) METHOD FOR PREDICTING WEAR AMOUNT OF CHAIN PIN OF ROLLER CHAIN BY USING FRICTION NOISE

(71) Applicant: KOREA CONVEYOR CO., LTD, Seoul (KR)

(72) Inventor: Kwang Soon KIM, Seoul (KR)

(21) Appl. No.: 16/639,921

(22) PCT Filed: Jan. 8, 2018
(86) PCT No.: PCT/KR2018/000375

§ 371 Date: Feb. 18, 2020

(30) Foreign Application Priority Data
Aug. 17, 2017 (KR) 10-2017-0103898

(51) Int. Cl. G01N 3/56; B65G 43/02

(52) U.S. Cl. CPC G01N 3/56; B65G 17/38; B65G 43/02

(57) ABSTRACT

The method for predicting a wear amount of a chain pin by using a friction noise according to an embodiment of the present invention predicts a wear amount of a chain pin of a roller chain by using a friction noise while the roller chain is revolved by a driving force of a sprocket. The method includes: sensing a noise around the roller chain by means of a noise sensing unit; separating a friction noise between rollers of the roller chain and teeth of the sprocket from the sensed noise around the roller chain by means of a sound source separation unit; and predicting a wear amount of the chain pin using the separated friction noise between the rollers and the teeth by means of a sound source analysis unit.

### TECHNICAL FIELD

The present invention relates to a method for predicting a pin wear amount of a roller chain and, particularly, to a method for predicting a wear amount of a chain pin by using a friction noise that is generated by friction between a roller of a chain and a sprocket when the chain is revolved in engagement with grooves of the sprocket.

### BACKGROUND ART

In general, a conveyor is a device for conveying objects and is classified into a roller type including several rollers disposed with predetermined gaps to support objects, a roller chain type including a caterpillar to support objects and being driven by a roller chain, etc.

As shown in FIG. 2, a roller chain for a common conveyed including first link units and second link units continuously linked to each other.

The first link unit is composed of a several rollers 103 disposed in parallel with predetermined gaps, several bushes 102 rotatably fitted through the rollers 103, and a link plate 101 fixed to the outer sides of both ends of a pair of bushes 102, in which the rollers 103 rotatably fitted on the bushes 102 and a sprocket is inserted and supported between a pair of rollers 103, whereby a driving force of the sprocket is transmitted to the rollers 103.

The second unit is composed of pins rotatably fitted through the bushes 102 and a pin link 105 coupled to both ends of the pin of one link plate 101 and the pin 104 of another link plate 101. The pin link 105 is coupled to the bushes 102 of the first link unit by the pins 104, so it is linked to the link plate 101 to be able to revolve.

As shown in FIG. 2, when a roller 103 is supported by the sprocket S, the roller 103 transmits the driving force of the sprocket S to the bush 102 and the pin 104 and is rotated with respect to the bush 102. In this case, when the sprocket S is rotated with the rollers 103, the bushes 102, and the pins 104 continuously internally in contact with each other, torque is transmitted to the pins 104 and the pins 104 can be rotated with respect to the link plates 101. Accordingly, this operation is repeated and the pins 104 are worn due to a long-time operation.

When the pin 104 of the roller chain is worn, the gap between the outer side of the pin 104 and the inner side of the bush 102 increases (indicated by A in FIG. 2), so the distance between the rollers 103 changes. In this case, in a normal state shown at the left side (a) in FIG. 3, the distance between the rollers 103 is uniform, but at the right side (b), the gap between the rollers 103 increases due to wear of the pins 104, so the rollers cannot be stably seated in the grooves of the sprocket S and impact is continuously applied to the teeth of the sprocket S, whereby the sprocket S may be damaged.

However, there is not technique that predicts a wear amount of chain pins while such a roller chain is revolved in the related art. In the related art, a wear amount of chain pins are detected by measuring the length of a roller chain that has been used for a predetermined time using a ruler. However, there is a problem in the technique that the roller chain has to be stopped to measure the wear amount of the chain pins.

### DISCLOSURE

### Technical Problem

Accordingly, the present invention provides a method for predicting a wear amount of a chain pin, the method being able to predict a wear amount of a chain pin while a roller chain is operated by a driving force of a sprocket.

The present invention provides a method for predicting a wear amount of a chain pin by using a friction noise that is generated by friction between a roller of a roller chain and a tooth of a sprocket due to wear of a chain pin when the roller chain is revolved in engagement with the grooves of the sprocket.

### Technical Solution

The method for predicting a wear amount of a chain pin by using a friction noise according to an embodiment of the present invention predicts a wear amount of a chain pin of a roller chain by using a friction noise while the roller chain is revolved by a driving force of a sprocket. The method includes: sensing a noise around the roller chain by means of a noise sensing unit; separating a friction noise between rollers of the roller chain and teeth of the sprocket from the sensed noise around the roller chain by means of a sound source separation unit; and predicting a wear amount of the chain pin using the separated friction noise between the rollers and the teeth by means of a sound source analysis unit.

The method may further include outputting the predicted wear amount of the chain pin by means of an output unit.

In the method, when the friction noise between the rollers and the sprocket is received from the sound source separation unit, the sound source analysis unit may extract chain pin wear amount information corresponding to the received friction noise between the rollers and the sprocket using relationship between a chain wear amount and a friction noise between the rollers and the sprocket that are stored in advance in a database.

In the method, the sound source analysis unit may receive a waveform of a friction noise between the rollers and the sprocket according to time from the sound source separation unit and predict a wear amount of the chain pin by comparing time differences between adjacent waveforms in the received waveform of the friction noise according to time.

In the method, the larger the time difference between adjacent waveforms, the larger the wear amount of the chain pin may be predicted by the sound source analysis unit.

The sound source analysis unit may extract the time difference between adjacent waveforms and extracts a chain pin wear amount information corresponding to the received extracted time difference using relationship a chain pin wear amount and a time difference between waveforms of a friction noise between the rollers and the sprockets that are stored in advance in a database.

### Advantageous Effects

According to the present invention, since a friction noise that is generated by friction with the teeth of a sprocket when a roller chain is revolved in engagement with the grooves of the sprocket is used, it is possible to predict a wear amount of a chain pin even while the roller chain is operated by a driving force of the sprocket.

### DESCRIPTION OF DRAWINGS

FIG. 1 is an exploded perspective view of a common roller chain in the related art;

FIG. 2 is an exemplary view in which a roller chain and a sprocket are combined in the related art;

FIG. 3 is an exemplary view in which a roller chain and a sprocket are combined with chain pins worn in the related art;

FIG. 4 is a view showing the configuration of a system for performing a method of predicting a wear amount of a chain pin by using friction noise according to an embodiment of the present invention;

FIG. 5 is a view showing a test result of separating various friction noises from a chain noise of a roller chain according to an embodiment of the present invention;

FIG. 6 is an exemplary view showing waveforms of a friction noise between rollers and teeth, as time passes, in accordance with an embodiment of the present invention; and

FIG. 7 is a flowchart showing a method for predicting a wear amount of a chain pin by using a friction noise according to an embodiment of the present invention.

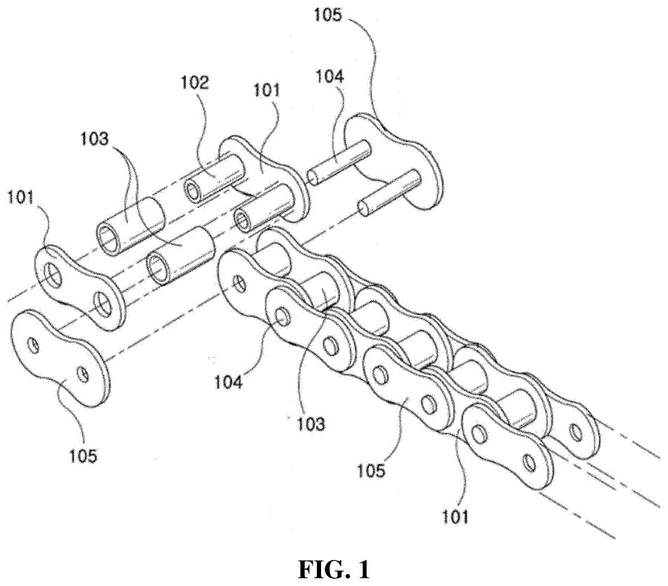

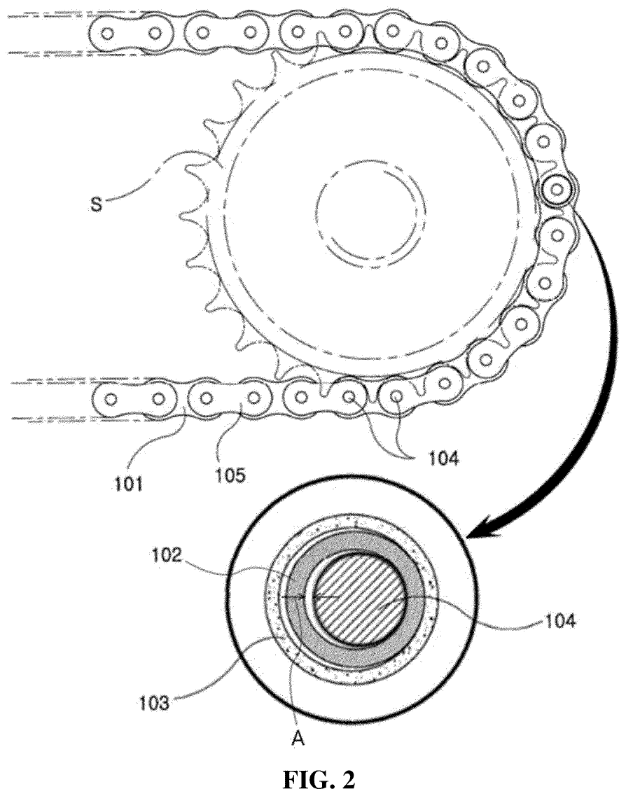

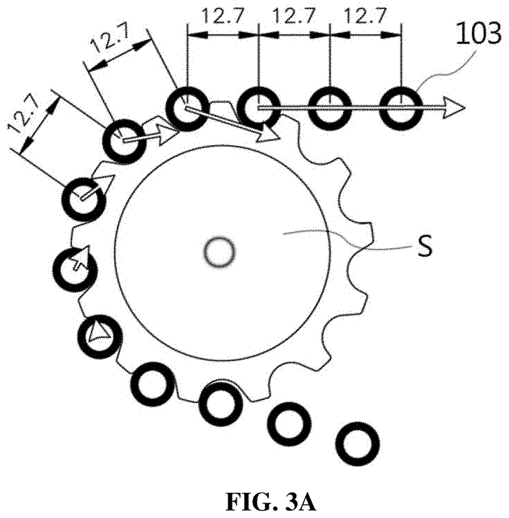

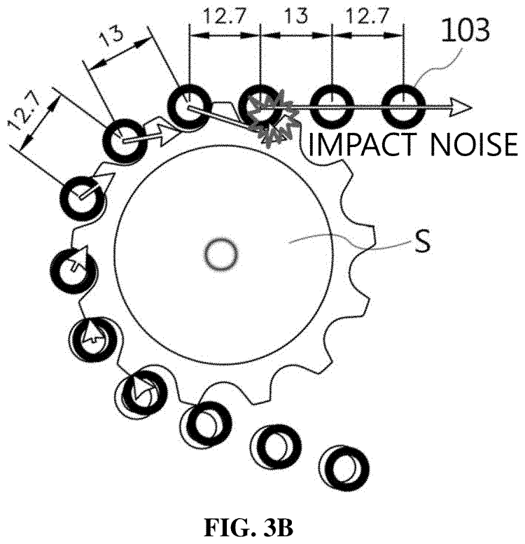

### MODE FOR INVENTION

Hereinafter, embodiments of the present invention are described in detail with reference to exemplary drawings. It should be noted that when components are given reference numerals in the drawings, the same components are given the same reference numerals even if they are shown in different drawings. In the following description of embodiments of the present invention, when detailed description of well-known configurations or functions is determined as interfering with understanding of the embodiments of the present invention, they are not described in detail.

Further, terms “first”, “second”, “A”, “B”, “(a)”, and “(b)” can be used in the following description of the components of embodiments of the present disclosure. The terms are provided only for discriminating components from other components and, the essence, sequence, or order of the components are not limited by the terms. When a component is described as being “connected”, “combined”, or “coupled” with another component, it should be understood that the component may be connected or coupled to another component directly or with another component interposing therebetween.

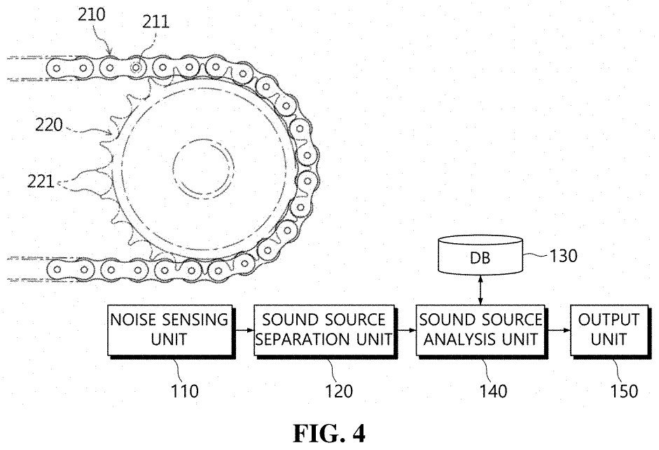

FIG. 4 is a view showing the configuration of a system for performing a method of predicting a wear amount of a chain pin by using friction noise according to an embodiment of the present invention.

Referring to FIG. 4, a system 100 according to an embodiment of the present invention includes a noise sensing unit 110, a sound source separation unit 120, a database (DB) 130, a sound source analysis unit 140, and an output unit 150.

The noise sensing unit 110 senses a noise that is generated by a chain 210 and a sprocket 220 while the chain 210 supported by the sprocket 220 is operated by a driving force of the sprocket 220. The sensed noise is created as a frequency signal or a digital datum. Torque can be applied to the sprocket 220 by a motor (not shown).

The noise sensing unit 110 may be attached to a side of the sprocket 220 or may be installed in a space at a predetermined distance from the chain 210 and the sprocket 220. The noise sensing unit 110 can be installed at any position as long as it can effectively sense a noise that is generated when the chain 210 and the sprocket 220 are operated.

There are various noises that are sensed by the noise sensing unit 110. For example, there are various noises including a friction noise that is generated by friction between rollers 211 of the chain 210 and teeth 221 of the sprocket 220, a friction noise between pins and bushes of the chain 210, a friction noise between the rollers 211 and the bushes, a noise due to the motor (not shown). The friction noise between the rollers and the teeth includes an impact noise therebetween.

The sound source separation unit 120 receives a noise sensed by the noise sensing unit 110 and separates a friction noise between the chain 210 and the sprocket 220 from various noises. In this case, a friction noise due to friction between the rollers 211 of the chain 210 and the teeth 221 of the sprocket 220 is separated. Such a friction noise also has a frequency signal or digital data type.

The technique for separating a friction noise between the rollers 211 and the teeth 221 from noises uses a well-known sound source separation technique. For example, a sound source separation technique based on a frequency analysis result of a complex sound and various sound source elements, a sound source separation technique that specifies the spatial position of a sound source using a directional microphone, and a sound signal grouping and separating technique that uses a stacked autoencoder may be used (see pp. 303-309, No. 4, 35^{th} Volume, Journal of Acoustic Society of Korea).

The present invention, for example, may use a sound signal separation technique that uses a stacked autoencoder. The sound signal separation technique, which uses a multi-layer magnetic encoder employs a stacked autoencoder that is a kind of deep neural network (DNN) for input through a single microphone and can separate a sound source using the stacked autoencoder, learns and automatically groups two or more mixed input signals such that characteristics of sound sources are discriminated, and discriminates elements signals that are appropriately classified. According to the sound signal separation technique, it is possible to efficiently separate sound sources having two or more different characteristics using a stacked autoencoder.

The database (DB) 130 stores in advance predetermined various friction noises in a digital data type. Further, the DB 130 stores in advance relationship information of various friction noises according to the states of the chain 210 and the sprocket 22. In particular, according to the present invention, a friction noise between the rollers 211 and the teeth 221 is stored, that is, relationship information of the friction noise between the rollers 211 and the teeth 221 in response to a variation of a wear amount of chain pins is stored in advance.

Accordingly, it is possible to recognize a friction noise according to a wear amount of chain pins by using the information stored in advance in the DB 130, and when a friction noise is known, it is possible to know a wear amount of a pin corresponding to the friction noise.

The sound source analysis unit 140 extracts a wear amount of a chain pin corresponding to a friction noise that is sensed and separated, as described above, by receiving a friction noise between the rollers 211 and the teeth 221 separated by the sound source separation unit 120 and by checking the relationship between the friction noises stored in advance in the DB 130 and a wear amount of a chain pin.

The output unit 150 outputs a chain pin wear amount value that is extracted as described above. Accordingly, a user can know a chain pin wear amount that is shown through a display.

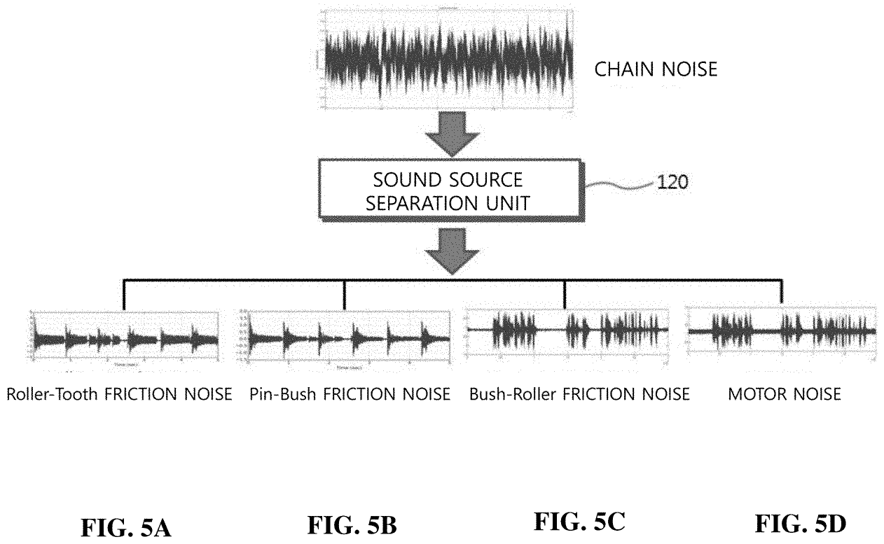

FIG. 5 is a view showing a test result of separating various friction noises from a chain noise of a roller chain according to an embodiment of the present invention.

Referring to FIG. 5, in a test example according to an embodiment of the present invention, a chain noise sensed by the noise sensing unit 110 is input to the sound source separation unit 120 to be separated into various different noises. As shown in the figure, the chain noise is composed of a friction noise between a roller and a tooth (a), a friction noise between a pin and a bush (b), a friction noise between a bush and a roller (c), and a motor noise (d), and these noises a˜d are separated by a sound signal separation technique using a stacked autoencoder according to the present invention.

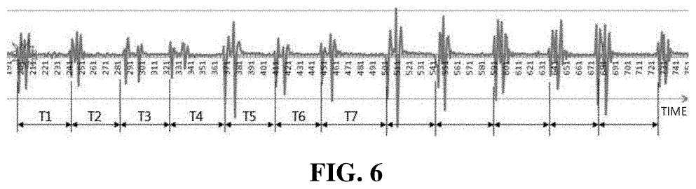

FIG. 6 is an exemplary view showing waveforms of a friction noise between rollers and teeth, as time passes, in accordance with an embodiment of the present invention.

Referring to FIG. 6, a friction noise between the rollers 211 and the teeth 221 is separated from a chain noise and then the friction noise is shown as waveforms according to time in the present invention. The waveforms according to time are based on impact or friction due to contact between the rollers 211 and the teeth 221 and the time differences between the waveforms are based on the continuously connected rollers 211. Accordingly, when the pin of a specific roller 211 is worn, the distance between the specific roller 211 and an adjacent roller increases, so the time difference between waveforms increases.

As shown in the test example of FIG. 6, it can be seen that the same time difference between waveforms is maintained for T1, T2, T3, T5, and T6, but the time difference between waveforms relatively increases for T4 and T7. The DB 130 stores in advance not only a normal waveform between roller and teeth, but also waveforms according to wear amounts of pins and time difference information between waveforms for the wear amounts.

Accordingly, the sound source analysis unit 140 predicts a wear amount of a chain pin by comparing the waveforms between the rollers and the teeth stored in advance in the DB 130 and a waveform for a friction noise between the rollers and the teeth output from the sound source separation unit 120. In particular, a wear amount of a chain pin is predicted using the waveform of a friction noise between a roller and a tooth, that is, in detail, a time difference between waveforms according to time, as shown in the figure.

In detail, the sound source analysis unit 140 receives the waveform of a friction noise between the rollers and the sprocket according time from the sound source separation unit 120 and predicts a wear amount of a chain pin by comparing the time differences between adjacent waveforms in the received waveform of a friction noise according to time. The larger the time difference between adjacent waveforms, the larger the wear amount of a chain pin is predicted. This is because the larger the wear amount of a chain pin, the larger the gap from a bush, so the larger than distance between rollers as much as the gap.

In another example, when receiving a friction noise waveform between the rollers and the sprocket according to time from the sound source separation unit 120, the sound source analysis unit 140 extracts the time difference between adjacent waveforms and extracts chain pin wear amount information corresponding to the extracted time difference using the relationship between the time difference between the waveforms of the friction noise between the rollers and the sprocket and a chain pin wear amount that are stored in advance in the DB 130.

To this end, the DB 130 stores in advance not only the waveforms for a friction noise between the rollers and the sprocket and relationship information between the time difference between adjacent waveforms in the waveforms and a chain pin wear amount corresponding to the time difference. Accordingly, when a time difference between adjacent waveforms is extracted, it is possible to extract a wear amount of a chain pin using the DB 130.

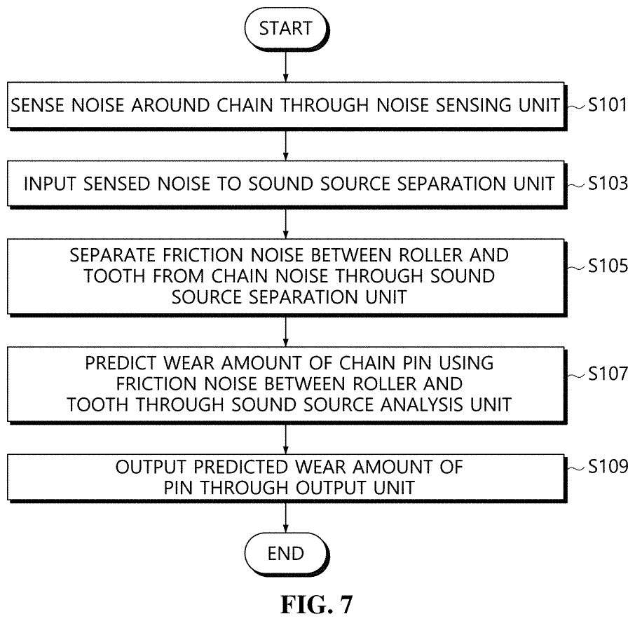

FIG. 7 is a flowchart showing a method for predicting a wear amount of a chain pin by using a friction noise according to an embodiment of the present invention.

Referring to FIG. 7, in the method for predicting a wear amount of a chain pin by using a friction noise according to the present invention, a noise around a chain is sensed through the noise sensing unit 110 attached to the sprocket 120 or installed around the chain (S101). As the surrounding noise, there is a noise that is generated around the chain 210, the sprocket 220, and the motor (not shown). In particular, the chain noise includes impact between the rollers 211 of the chain 210 and the teeth 221 of the sprocket 120 and a friction noise (including shock noise) due to friction.

The sensed noise is input to the sound source separation unit 120 (S103) and the sound source separation unit 120 separates different noises on the basis of the characteristics of the noises (S105). As described above, in the present invention, sound sources are separated using the sound signal separation technique that uses a stacked autoencoder that can efficiently separate sound sources having two or more different characteristics. A friction noise between the rollers 211 and the teeth 221 is included in the separated sound sources.

Thereafter, the sound source analysis unit 140 predicts a wear amount of a chain pin using the friction noise waveform between the rollers 211 and the teeth 221. In detail, when a friction noise between the rollers and the teeth is received from the sound source separation unit 120, the sound source analysis unit 140 extracts a chain pin wear amount by checking a chain pin wear amount corresponding to the friction noise using the relationship between the friction noise between the rollers and the teeth and the chain pin wear amount that are stored in advance in the DB 130.

Next, the output unit 150 visually or aurally outputs the predicted pin wear amount (S109). Accordingly, a user can know the wear amount.

As described above, in the present invention, a friction noise that is generated between the rollers of a roller chain and the teeth of a sprocket is separated from a noise through a sound source separation technique by sensing the noise that is generated around the chain, and a wear amount corresponding to the friction noise is recognized by searching a DB.

Accordingly, it is possible to measure a pin wear amount of a roller chain in on-line while the roller chain supported by a sprocket is revolved by a driving force of the sprocket.

Even through all components of embodiments of the present invention are combined in one unit or operated in combination in the above description, the present invention is not limited thereto. That is, the all components may be selectively combined and operated within the scope of the present invention. Further, the terms “comprise”, “include”, “have”, etc. when used in this specification mean that the components can exist inside unless specifically stated otherwise, so they should be construed as being able to further include other components. Unless otherwise defined, all terms including technical and scientific terms used herein have the same meaning as commonly understood by those skilled in the art to which the present invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

The above description merely explains the spirit of the present disclosure and the present disclosure may be changed and modified in various ways without departing from the spirit of the present disclosure by those skilled in the art. Accordingly, the embodiments described herein are provided merely not to limit, but to explain the spirit of the present disclosure, and the spirit of the present disclosure is not limited by the embodiments. The protective range of the present disclosure should be construed by the following claims and the scope and spirit of the present disclosure should be construed as being included in the patent right of the present disclosure.

1. A method for predicting a wear amount of a chain pin of a roller chain by using a friction noise while the roller chain is revolved by a driving force of a sprocket, the method comprising:
sensing a noise around the roller chain by means of a noise sensing unit;
separating a friction noise between rollers of the roller chain and teeth of the sprocket from the sensed noise around the roller chain by means of a sound source separation unit; and
predicting a wear amount of the chain pin using the separated friction noise between the rollers and the teeth by means of a sound source analysis unit.

2. The method of claim 1, further comprising outputting the predicted wear amount of the chain pin by means of an output unit.

3. The method of claim 1, wherein when the friction noise between the rollers and the sprocket is received from the sound source separation unit, the sound source analysis unit extracts chain pin wear amount information corresponding to the received friction noise between the rollers and the sprocket using relationship between a chain wear amount and a friction noise between the rollers and the sprocket that are stored in advance in a database.

4. The method of claim 1, wherein the sound source analysis unit receives a waveform of a friction noise between the rollers and the sprocket according to time from the sound source separation unit and predicts a wear amount of the chain pin by comparing a time difference between adjacent waveforms in the received waveform of the friction noise according to time.

5. The method of claim 4, wherein the larger the time difference between adjacent waveforms, the larger the wear amount of the chain pin is predicted by the sound source analysis unit.

6. The method of claim 4, wherein the sound source analysis unit extracts the time difference between adjacent waveforms and extracts a chain pin wear amount information corresponding to the received extracted time difference using relationship a chain pin wear amount and a time difference between waveforms of a friction noise between the rollers and the sprockets that are stored in advance in a database.
